(19) United States
(12) Patent Application Publication
(10) Pub. No.: US 2009/0070459 A1
(43) Pub. Date: Mar. 12, 2009

(54) High-Performance Context-Free Parser for Polymorphic Malware Detection

(76) Inventors: Young H. Cho, Chatsworth, CA (US); William H. Mangione-Smith, Kirkland, WA (US)

Correspondence Address: CHRISTIE, PARKER & HALE, LLP, PO BOX 7068, PASADENA, CA, 91109-7068, US

(21) Appl. No.: 11/918,592

(22) PCT Filed: Apr. 18, 2006
(86) PCT No.: PCT/US2006/014574

§ 371 Date: Oct. 12, 2007

Related U.S. Application Data
(60) Provisional application No. 60/672,244, filed on Apr. 18, 2005.

(51) Int. Cl. G06F 15/16

(52) U.S. Cl. 709/224

(57) ABSTRACT

The invention provides a method and apparatus for advanced network intrusion detection. The system uses deep packet inspection that can recognize languages described by context-free grammars. The system combines deep packet inspection with one or more grammar parsers (409A-409M). The invention can detect token streams (408) even when polymorphic. The system looks for tokens at multiple byte alignments and is capable of detecting multiple suspicious token streams (408). The invention is capable of detecting languages expressed in LL(I) or LR(I) grammar. The result is a system that can detect attacking code wherever it is located in the data stream (408).

This invention was made with United States government assistance through National Science Foundation (NSF) Grant No. CCR-0220100. The government has certain rights in this invention.

### RELATED APPLICATION

This patent application claims priority to provisional patent application No. 60/672,244 filed on Apr. 18, 2005 and incorporated by reference herein in its entirety.

### BACKGROUND OF THE INVENTION

Computer viruses and other types of malware have become an increasingly common problem for computer networks. To defend against network attacks, many routers have built-in fireballs that can classify packets based on header information. Such defenses, sometimes referred to as “classification engines” can be effective in stopping attacks that target protocol specific vulnerabilities. However, they are not able to detect some malware (e.g. worms) that is encapsulated in the packet payload. One method used to detect such an application-level attack is called “deep packet inspection”. A system with a deep packet inspection engine can search for one or more specific patterns in all parts of the packets, not just the headers. Although deep packet inspection increases the packet filtering effectiveness and accuracy, most of the current implementations do not extend beyond recognizing a set of predefined regular expressions.

Deep packet inspection is designed to search and detect the entire packet for known attack signatures. However, due to its high processing requirement, implementing such a detector using a general purpose processor is costly for multi-gigabit per second (Gbps) networks. Therefore, many researchers have attempted to develop cost-efficient high-performance pattern matching engines and processors for deep packet inspection. Such systems are described in Y. H. Cho, S. Navab, and W. H. Mangione-Smith “Specialized Hardware for Deep Network Packet Filtering” 12^{th} Conference on Field Programmable Logic and Applications, pages 452-461, Montpelier, France, September 2002. Springer-Verlag. and Y. H. Cho and W. H. Mangione-Smith “A Pattern Matching Co-processor for Network Security” IEEE/ACM 42^{nd} Design Automation Conference, Anaheim, Calif., June 2005.

Although prior art pattern matching filters can be useful for finding suspicious packets in network traffic, they are not capable of detecting other higher-level characteristics that are commonly found in malware.

For example, polymorphic virus such as Lexotan and W95/Puron attack by executing the same instructions in the same order, with garbage instructions, and jumps inserted between the core instructions differently in subsequent generations. As illustrated in FIG. 1, a simple pattern search can be ineffective or prone to false positives for such an attack since the sequence of bytes is different based on the locations and the content of the inserted codes. Referring to FIG. 1, code segment 101 is a common target instruction in viruses. Segment 102 shows a possible byte sequence to search for when seeking the presence of the virus. Segment 103 shows the code containing the actual sequence being sought. The actual instructions 104 show that segment as part of a NOP instruction. Missing, however, is the target instruction. This leads to false positives when only pattern matching is used.

### SUMMARY OF THE INVENTION

The invention provides a method and apparatus for advanced network intrusion detection. The system uses deep packet inspection that can recognize languages described by context-free grammars. The system combines deep packet inspection with one or more grammar parsers. The invention can detect token streams even when polymorphic. The system looks for tokens at multiple byte alignments and is capable of detecting multiple suspicious token streams. The invention is capable of detecting languages expressed in LL(1) or LR(1) grammar. The result is a system that can detect attacking code wherever it is located in the data stream.

These and other features and advantages of the claimed invention will become apparent from the following detailed description when taken in conjunction with the accompanying drawings, which illustrate, by way of example, the features of the claimed invention.

### BRIEF DESCRIPTION OF THE DRAWINGS

FIG. 1 is an example of a code segment of a polymorphic virus.

FIG. 2 is a diagram of the operation of a compiler.

FIG. 3 is an example of language syntax.

FIG. 4 is a block diagram of an embodiment of a packet inspector.

FIG. 5 is an example of multiple token streams from a single data stream.

FIG. 6 is a diagram of an embodiment of a tokenizer of the invention.

FIG. 7 is an example of multiple pattern threads in a single token sequence.

FIG. 8 is a block diagram of an embodiment of an LL parser.

FIG. 9 is an example of instruction types for an LL(1) parser.

FIG. 10 is a block diagram of an embodiment of an LL(1) parser.

FIG. 11 is a block diagram of an embodiment of an LR parser.

FIG. 12 is an example of instruction types for an LR(1) parser.

FIG. 13 is a diagram of an embodiment of an LR(1) parser.

FIG. 14 is an example of instruction types for a parser.

FIG. 15 is a diagram of an embodiment of a combined parser design.

FIG. 16 is an example of an embodiment of a multiple thread parser stack.

FIG. 17 is an example of an embodiment of a two thread parser stack. ,

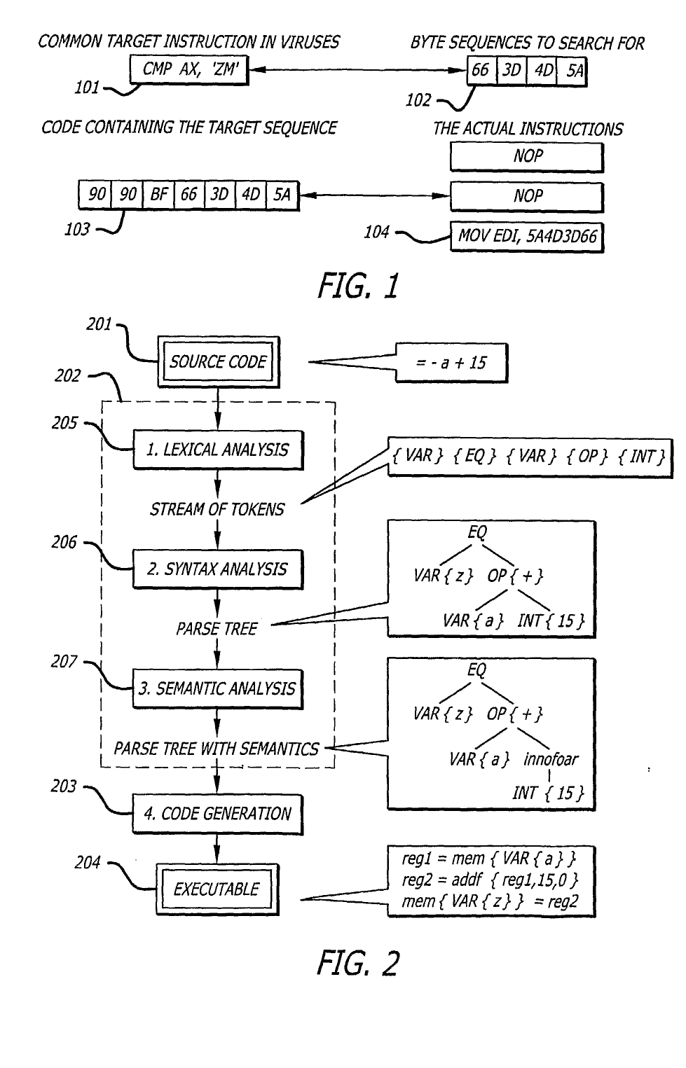

### DETAILED DESCRIPTION OF THE PREFERRED EMBODIMENTS

In the following description of the invention, reference is made to the accompanying drawings that form a part hereof, and in which is shown by way of illustration a specific embodiment in which the invention may be practiced. It is to be understood that other embodiments may be utilized and structural-changes may be made without departing from the scope and spirit of the invention.

The invention provides a combination of deep packet inspection and a grammar scan to detect sting pattern, regular expressions and languages expressed in LL(1) or LR(1) grammar. A header and payload inspection is followed by a tokenizing step. The token streams are parsed so that syntactic structure can be recognized. The invention may be understood by examining approaches of intrusion detection.

One prior art intrusion detection system is known as “Snort”. Snort is an open source intrusion detection system with configuration files that contain updated network worm signatures. Since the database of the signature rules are available to the public, many researchers use it to build high performance pattern matchers for their intrusion detection systems.

Dynamic Payload Inspection

One technique for searching a packet payload is called “dynamic payload inspection”. The dynamic pattern search is a computationally intensive process of deep packet inspection. Some prior art systems use field programmable gate arrays to implement search engines capable of supporting high-speed networks. It has been shown that the patterns can be translated into non-deterministic and deterministic finite state automata to effectively map on to FPGAs to perform high-speed pattern detection. It has also shown that the area efficient pattern detectors can be built by optimizing the group of byte comparators that are pipelined according the patterns. One approach uses chains of byte comparators and read-only-memory (ROM) to reduce the amount of logic by storing parts of the data in memory

In other instances, pattern matching has been done using programmable memories without using reconfigurable hardware technology. Gokhale et al. implemented a reprogrammable pattern search system using content addressable memories (CAM). M. Gokhale, D. Dubois, A. Dubois, M. Boorman, S. Poole, and V. Hogsett. Granidt: “Towards Gigabit Rate Network Intrusion Detection Technology”. 12th Conference on Field Programmable Logic and Applications, pages 404-413, Montpellier, France, September 2002. Springer-Verlag. . Dharmapurikar et al. use Bloom filters with specialized hash functions and memories S. Dharmapurikar, P. Krishnamurthy, T. Sproull, and J. Lockwood. “Deep Packet Inspection using Parallel Bloom Filters” IEEE Hot Interconnects 12, Stanford, Calif., August 2003. IEEE Computer Society Press. J. Lockwood, J. Moscola, M. Kulig, D. Reddick, and T. Brooks. “Internet Worm and Virus Protection in Dynamically Reconfigurable Hardware” Military and Aerospace Programmable Logic Device (MAPLD), Washington D.C., September 2003. NASA Office of Logic Design. J. Moscola, J. Lockwood, R. Loui, and M. Pachos. “Implementation of a Content-Scanning Module for an Internet Firewall” IEEE Symposium on Field-Programmable Custom Computing Machines, Napa Valley, CA, April 2003. IEEE. Yu et al. use TCAM to build high performance pattern matcher that is able to support gigabit network F. Yu, R. H. Katz, and T. Lakshman. “Gigabit Rate Packet Pattern-Matching Using TCAM” 12th IEEE International Conference on Network Protocols (ICNP), Berlin, Germany, October 2004. IEEE.

One system implements an ASIC co-processor that can be programmed to detect the entire Snort pattern set at a rate of more than 7.144 Gbps. Y. H. Cho and W. H. Mangione-Smith. “A Pattern Matching Co-processor for Network Security” IEEE/ACM 42nd Design Automation Conference, Anaheim, CA, June 2005. IEEE/ACM.

Language Parser Acceleration

Due to the increasing use of the Extensible Markup Language (XML) in communication, there has been some interest for a hardware based XML parser. Companies such as Tarari, Datapower, and IBM have developed acceleration hardware chips that are capable of parsing XML at a network bandwidth of gigabit per second. These devices use the underlying concepts from software compiler technology. However, there are additional problems that need to be considered for using the technology in detecting hidden programs in network packet payload.

Language Recognition

An important objective of a computer program compiler is accurate language recognition. As shown in the example of FIG. 2, current compilers work in phases where the input is transformed from one representation to another. The source code 201 is converted through analysis phase 202 and code generation phase 203 to executable code 204. The analysis phase 202 is itself made up of a number of analysis steps. Step 205 is lexical analysis where the input program 201 is scanned and filtered to construct sequence of patterns called tokens.

Then the sequence of tokens is forwarded to the parser for syntactic analysis at step 206. At step 206, the syntax of the input program is verified while also producing its parse tree. The parse tree is used as a framework to check and add semantics of each functions and variables in the semantic analysis phase of step 207. The output of this analysis is used in the later stages to optimize and generate executable code 204 for the target architecture.

Lexical and syntactic analysis are mainly responsible for verifying and constructing software structure using the grammatical rules while semantic analysis is responsible for detecting semantic errors and checking type usage.

Context Free Grammar

Many commonly used programming languages are defined with context-free grammar (CFG). A context free grammar is a formal way to specify a class of languages. It consists of “tokens”, “nonterminals”, a “start” symbol, and “productions”. Tokens are predefined linear patterns that are the basic vocabulary of the grammar. In order to build a useful program structure with tokens, productions are used.

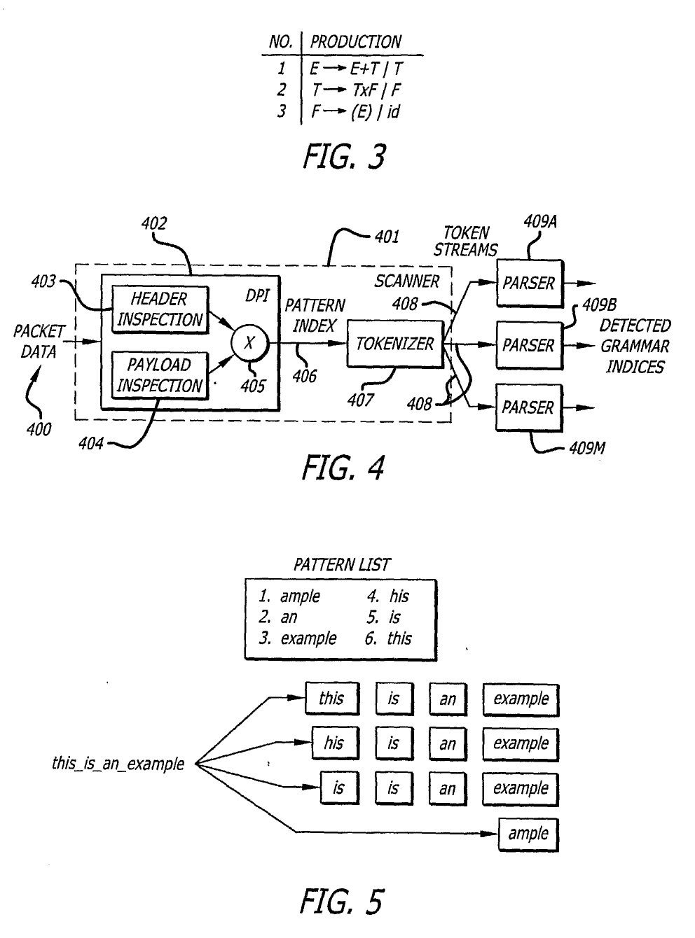

An example of notational convention for context free grammar in the invention is illustrated in FIG. 3. The grammar in the example of FIG. 3 expresses the syntax for a simple calculator. The grammar describes the order of precedence of calculation starting with parenthesis (Production 1), multiplication (Production 2), and, finally, addition (Production 3). This example consists of three production rules, each consisting of a nonterminal followed by an arrow and combination of nonterminals, tokens, and or symbol (expressed with a vertical bar). The left side of the arrow can be seen as a resulting variable whereas the right side is used to express the language syntax.

This formal representation is more powerful than the regular expression. In addition to regular expression, it is able to represent more advanced programming language structures such as balanced parenthesis and recursive statements like “if-then-else”. Given such powerful formal representation, it may be possible to devise a more efficient and accurate signature for advanced forms of attack. It is important to be able to detect these attacks.

Language Processing Phase

The phase that is used for detecting tokens from regular expressions is called the lexical analysis (step 205 in FIG. 2). In practice, the regular expressions are translated into deterministic finite automata (DFA) or non-deterministic finite automata (NFA). Then a state machine is generated to recognize the pattern inputs. This machine is often referred to as scanner.

As noted in FIG. 2, the syntactic analysis phase 206 follows immediately after lexical analysis 205. In the syntactic analysis phase 206, the grammar is used for verifying the language syntax and constructing the syntax data structure. The processing engine of this phase is called the parser. For modern compilers, the parsers are automatically generated according to the rules defined in the grammars.

Recognizing Network Packet

Computer program source codes are analyzed with a scanner and parser to determine correctness in the language structure. The invention applies this concept to the packet inspection system to effectively recognize structure within the network traffic.

FIG. 4 is a block diagram of an embodiment of the inspection process of the invention. After the header and the payload inspection, the pattern indices are converted to the streams of tokens by the scanner. The streams of tokens are then forwarded to the hardware parser to verify their grammatical structure. When the parser finds that the token stream conforms to the grammar, the packet can be marked as suspicious. Referring to FIG. 4, input packet data stream 400 is provided to scanner block 401. The scanner block consists in this embodiment of DPI (deep payload inspection) block 402 and tokenizer 407. DPI block 402 receives packet data stream 400 and separates it for header inspection 403 and payload inspection 404. The outputs of these blocks are combined at node 405 into a pattern index 406. Pattern index 406 is provided to tokenizer 407 for conversion to token streams 408. Token streams 408 are coupled to parsers 409A-409M that output detected grammar indices.

Input Data Scanner

The first phase of language recognition is the conversion of sequence of bytes to sequence of predefined tokens in scanner block 401. There are some similarities between the token scanner of the invention and the signature matcher designs discussed previously. Both systems are responsible for detecting and identifying predefined byte patterns from the stream of data input. However, the scanner is provided with a point in the input stream at which it is to produce sequence of tokens. Therefore, the token sequence produced by a lexical scanner is unique. By contrast, a signature matcher does not constrain where the embedded string starts; it simply detects matching patterns as it scans the stream at every byte offset.

Token Stream

It may not be possible to predict the start of a malicious code before processing begins. Thus, every token should be searched for at every byte offset to provide complete intrusion detection. When a token is detected at a given byte offset, the scanner inserts its offset to the output stream regardless of other tokens that might overlap the pattern. Since no two consecutive tokens from scanner input should overlap each other, the output should be reformed into one or more valid token streams.

A specific attack scheme can often embed its payload at more than one location within a packet. Therefore, the scanner of the invention looks for tokens at all byte alignments. Furthermore, the scanner maybe looking for several starting tokens for grammars representing different classes of attacks.

One problem is to find all the valid token streams in the payload. This is accomplished by distributing the pattern indices into the multiple number FIFOs, ensuring that each FIFO contains valid token streams. Another problem is to find the beginning of the attack in each stream. One approach is to assume that the all the tokens are the start of its own pattern thread. With this assumption, the parsing processor will attempt to parse every one of the pattern threads. In practice, this will not incur too much processing overhead because most threads will stop with an error after a short execution time. This process can be accelerated if the pattern matcher flagged all the tokens that are defined as start tokens. Given the bitmap of possible start tokens, the parser can skip to the next flagged token when the current token thread does not match the grammar.

FIG. 5 is an example of an embodiment of the invention and shows how one input byte stream may be properly recognized as four independent token streams. If we knew where the code started only one of the four streams would be of interest. Since the code of the attack may be located anywhere in the payload, all four streams must be considered viable threats. Therefore the pattern scanner of the invention produces multiple streams. Referring to FIG. 5, the pattern list consists of the tokens “ample”, “an”, “example”, “his”, “is”, and “this”. The input stream is the string “this_is_an_example”. As can be seen in FIG. 5, this string can produce at least four token streams that include tokens that are not obvious from a simple analysis of the input stream. Using offsets, a number of token streams are identified that include different tokens than are in the literal data stream.

In order to keep each stream separate, we modify our high-performance pattern matcher to provide pattern length and detection time information. In one embodiment, the pattern length information is loaded from the memory during the pattern matching process. Therefore, obtaining the length is a matter of synchronizing and outputting it with the index number. It can also be shown that index output is re-timed to synchronize with the first byte of the detected pattern in the input. Since the purpose of the time stamp is to show the relative cycle count between detections, it is sufficient to use the output of a simple counter that increments every cycle.

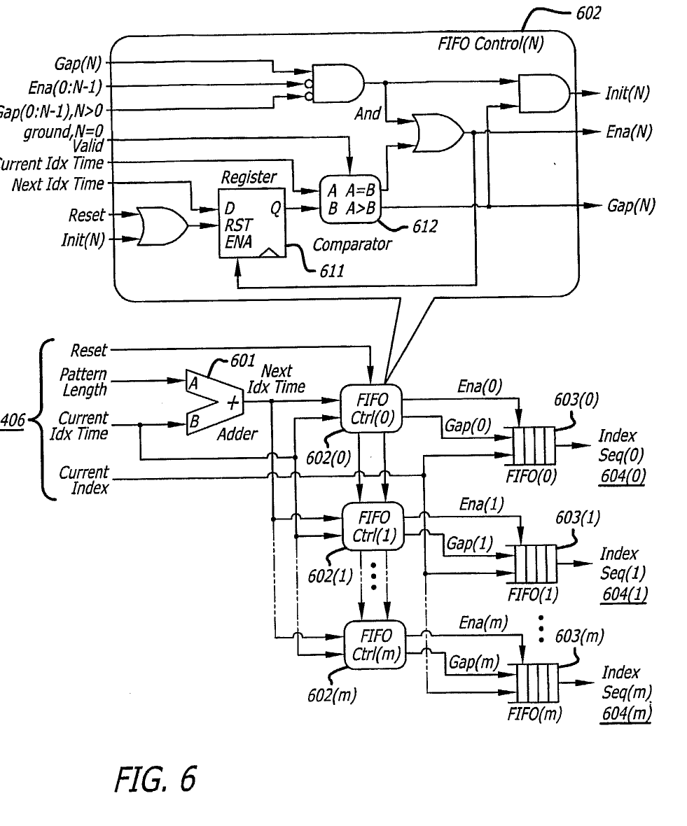

Once index, length, and time of a detected token are obtained, it can be determined whether any two tokens can belong to the same stream. A detailed view of an embodiment of the tokenizer 407 of FIG. 4 is illustrated in FIG. 6. The pattern index 406 is provided as input to adder 601 where the pattern length and current index time are combined. The next index time and current index time are provided as inputs to FIFO control blocks 602(0), 602(1) through 602(m). The output of the FIFO control blocks , along with the current index, is provided to FIFOs 603(0), 603(1), through 603(m) to produce index sequences 604(0), 604(1) through 604(m).

A detailed embodiment of the FIFO control block 602 is illustrated in FIG. 6. As shown in FIG. 6, the length of a newly detected token is added to the detection time and stored in the register 611 of an available FIFO control. Since each byte is processed in every cycle, this sum represents when the next valid token is expected to arrive within the same stream. Then, when the next pattern is detected, its detection time is compared at comparator 612 with the value stored in the register 611. If the time stamp is less than the stored value, it means that the two consecutive patterns are overlapping. So, the token may not be stored in the FIFO. If the time stamp is equal to the stored value, the index is stored in the FIFO since it indicates that the patterns abut. Finally, when the time stamp is greater than the stored value, it indicates that there was a gap between the tokens. Thus, if the token is not accepted by any other active FIFOs, it is stored along with a flag (gap signal) to show that there was a gap between the current token and the previous token.

The number of required FIFOs can vary depending on how the grammar and tokens are defined. Whenever one token is a substring of another pattern or concatenation of multiple patterns, it introduces the possibility of having one more valid token stream. Therefore, the grammar can be written to produce infinite number of token streams. When all the FIFOs become unavailable, the design can stall the pipeline until one of the FIFO become available or simply mark the packet in question as suspicious. However, such problem may be avoided by rewriting the token list and grammer to contain only the non-overlapping patterns.

Token Threads

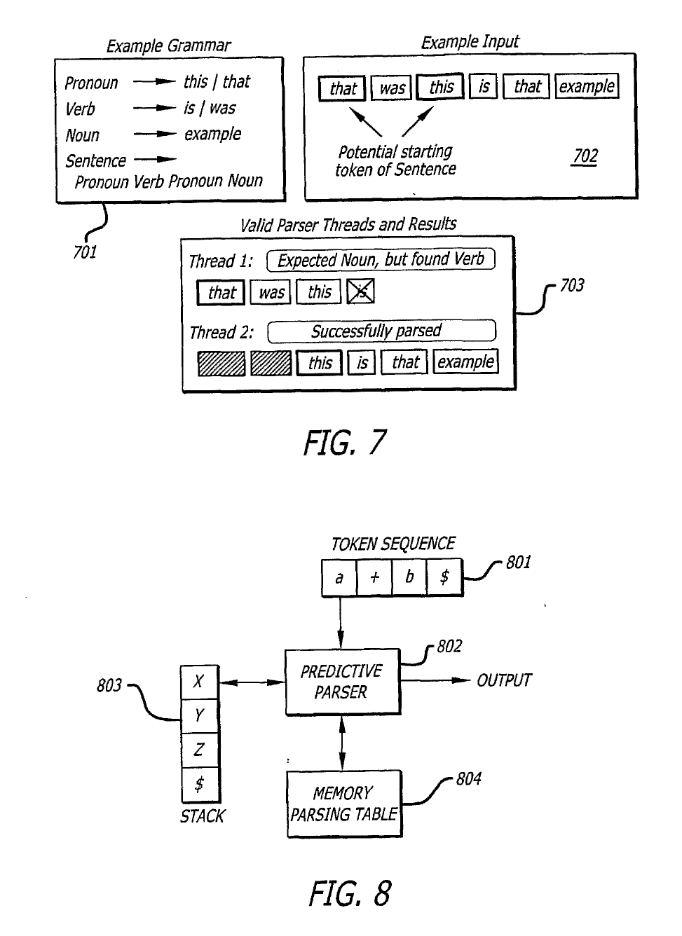

Although the original pattern stream is transformed into a number of valid token streams, the start token is still to be determined. FIG. 7 shows that more than one token sequence 702 that satisfies the grammar 701 can overlap throughout the entire token stream and that finding the start token of a sentence requires a higher level of language recognition.

In one embodiment, this problem is solved by assuming that every token is a starting token of the stream. In this solution, a stream with N tokens can be seen as N independent structures starting at different token offsets. Since each of these structures is processed separately, we refer to them as Token threads 703.

In one embodiment, pattern threads can be constructed using memory and registers to simulate the FIFO while maintaining the list of pattern thread pointers. For a small number of threads, specialized logic design may be easy to implement, but maintaining a larger number of threads maybe more cost effective to implement using a microcontroller.

Parser based Filter

Top-down parsers reorganize the syntactic structure of sentences by determining the content of the root node then filling in the corresponding leaf nodes as the program is processed in order. Bottom-up parsers, on the other hand, scan through sentences to determine the leaves of the branches before reducing up towards the root. The invention includes embodiments of parsers for dealing with both types.

Top-down Parsing

A predictive parser is one form of top-down parser. A predictive parser processes tokens from beginning to end to determine the syntactic structure of the input without backtracking to the previously processed tokens. The class of grammar that can be used to derive leftmost derivation of the program using the predictive parser is called LL grammar. The language described with an LL(n) grammar can be parsed by looking n tokens following the current token at hand.

FIG. 8 is a block diagram of table-driven predictive parser. The token sequence 801 is buffered in order, allowing the parser 802 to look at downstream tokens. The stack 803 in the system retains the state of the parser production. The parsing table is stored in memory 804.

Grammar Parsing

The simplest class of LL grammar is LL(1) where only a single token in the buffer is accessible to the parser at any one processing step. Since LL(1) grammar only requires the current state of the production and a single token to determine the next action, a 2-dimensional table can be formed to index all of the productions.

A proper LL(1) grammar guarantees that for any given non-terminal symbol and token, the next grammar production can be determined. Therefore, all grammar productions are stored in the parsing table according to corresponding non-terminals and tokens.

When parsing begins, the stack contains the start symbol of the grammar. At every processing step, the parser accesses the token buffer and the top of stack. If the parser detects that the new non-terminal is at the top of the stack, the first token in the buffer and the non-terminal is used to generate a memory index. At this time, the combination of symbols that do not have any production will trigger an error. Otherwise, the parser pops the non-terminal from the stack and uses the index to load and push the right side of the production onto the stack.

Whenever the top of stack is terminal term, it is compared with the token on the buffer. If two are the same, the token on the stack is popped as the buffer advance. If they do not match, parsing error is detected.

The operation of the parser pushes the corresponding terms in the table according to the non-terminal symbol at the top of the stack and the token buffer. Then as terminals in the productions are matched up with the token buffer, the FIFO and the terminals are removed for the next action.

LL(1) Parsing Processor

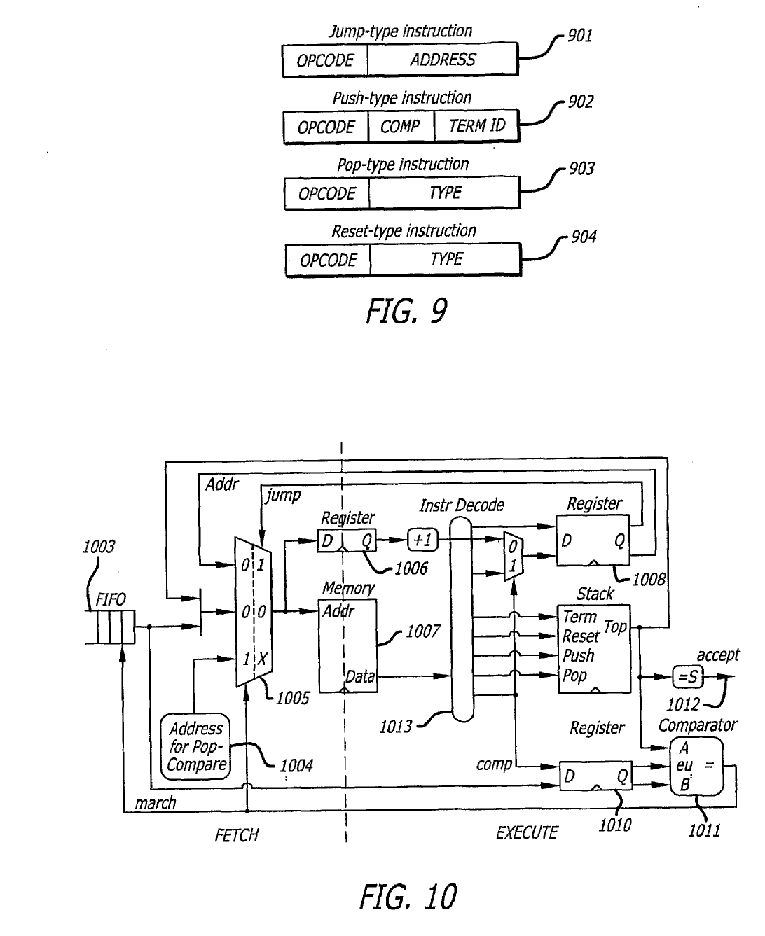

We can take the concepts of an LL(1) parser and implement it into a specialized processor. From our study of the LL(1) parsing, an embodiment of the invention provides an instruction set architecture consisting of seven operations classified into four types as shown in FIG. 9 and Table 1.

TABLE 1

| | Instruction | Function |
|---|---|---|
| 1 | JUMP(X) | Jump to address X |
| 2a | PUSH(X) | Push term X into the stack |
| | | Jump to the current address +1 |
| 2b | PUSHC(X) | Push term X into the stack |
| | | Compare the stack output with the |
| | | token |
| 3a | POP | Pop the stack |
| | | Compare the stack output with the |
| | | token |
| 3b | NOPOP | Compare the stack output with the |
| | | token |
| 4a | RESET | Reset the stack pointer |
| | | Push start term into the stack |
| 4b | ERROR | Reset the stack pointer |
| | | Push start term into the stacks |

FIG. 9 illustrates the format for Jump-type instructions 901, Push-type instructions 902, Pop-type instructions 903 and Reset-type instructions 904.

With an exception of instances where more than one symbol must be pushed into the stack, each table entry can be directly translated into a single instruction. Just like the parsing description, the address of the memory is obtained from stack and token buffer output. As for the exception, the memory address is obtained from the jump instruction which directs the processor to portions of the memory where the multiple number of instructions are executed sequentially. Once all the table entries are translated, the instructions can be stored in to a single memory, in order.

Based on the microcode definitions for each instruction, an embodiment of a co-processor is described in FIG. 10. The parser is a 2-stage pipelined processor that consists of instruction fetch stage 1001 followed by stack processing stage 1002. Since subsequent iterations of instructions are dependent on each other, each stage of the pipeline should process data independent instructions. Therefore, the design is utilized optimally when two or more independent processing threads are executed simultaneously. The instructions are provided to FIFO 1003. The are fed, along with a number of feedback loops, to selector 1005 which provides outputs to DQ register 1006 and memory 1007. The execution stack includes instruction decoder 1013, register 1008, stack 1009, and register 1010. The output of stack 1009 and register 1010 are proved to comparator 1011 whose output is provided to FIFO 1003 when there is a match. The output of stack 1009 is also output as accept value 1012.

Bottom-up Parsing

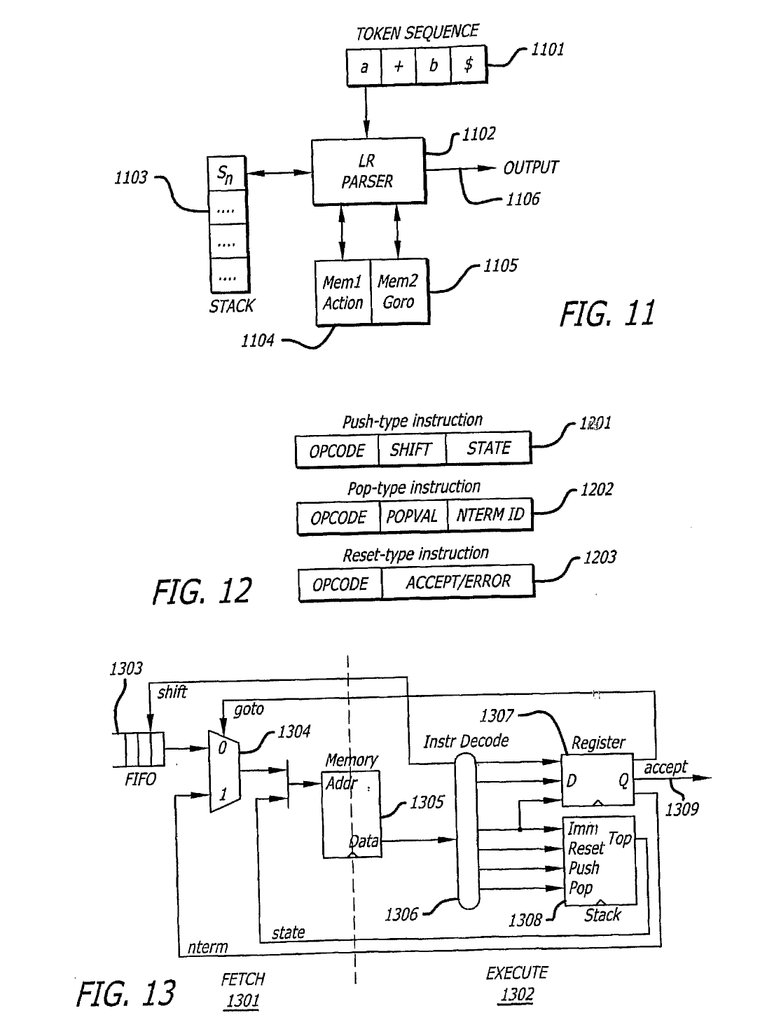

Like LL(1) parsing, the simplest form of LR (or bottom-up) parsing is LR(1) which uses 1 token look-ahead. FIG. 11 is a block diagram of table driven LR parser 1102 with token sequence 1101 to generate output 1106. The stack 1103 is used to keep track of state information instead of the specific production terms. Therefore, the parsing process and the tables contain different information. An LR parser has two tables instead of one, requiring two consecutive table look-ups for one parser action.

As with LL parsing, the grammar productions may need to be reformed to satisfy the parser constraints. Since the production terms are used to generate the contents of the table entries, during the parsing process the non-terminals on the left side of the arrow and the production element counts are used instead of the terms themselves.

Generating LR parsing tables from a grammar is not as intuitive process as LL(1) parser. Therefore, most parser generators automatically generate parsing table. Unlike the LL(1) table, there are two separate instruction look-up tables, action 1104 and goto 1105.

The stack is used exclusively to keep track of the state of the parser 1102. The action table 1104 is indexed by the top of stack entry. The action table entry 1104 contains one of four actions, shift, reduce, accept, and error. For shift action, the token is simply shifted out of the FIFO buffer and a new synthesized state is pushed onto the stack. The reduce action is used to pop one or more values from the stack. Then the address for the goto table 1105 is obtained using the non-terminal production and the parser state. The content of the goto table 1105 contains the next state which is then pushed in to the stack for next action. When parser 1102 reaches accept or error, the process is terminated.

LR(1) Parsing Processor

Just as with the LL(1) parser, an embodiment of the invention provides the instruction set and data types for the LR(1) parser. Although the parsing process of LR(1) is not readily obvious from the table entries, execution steps are simpler than LL(1) parsing.

Since, at most, one state symbol can be pushed in to the stack at one iteration, the jump instruction is unnecessary. Thus, there are only three types of instructions as shown on FIG. 12, Push-type instruction 1201, Pop-type instruction 1202, and Reset-type instruction 1203.

The instructions themselves (see Table 2) are also simpler in LR(1). The only exception is that the pop instruction requires that the stack is able to pop multiple items. Also the stack is only popped when a reduce action is executed. Therefore, the pop instruction will also cause the parser to access the goto table.

TABLE 2

| | Instruction | Function |
|---|---|---|
| 1a | PUSH(X) | Push state X into the stack |
| 1b | PUSHS(X) | Push state X into the stack |
| | | Shift to the next token |
| 2 | POP(X,Y) | Pop top X states of the stack |
| | | Use the Goto table with non-term Y |
| 3a | RESET | Reset the stack pointer |
| 3b | ERROR | Rest the stack pointer |
| 3c | ACCEPT | Reset the stack pointer |
| | | Assert the accept signal |

Conceptually, two separate memories are used for execution of reduce action. However, by forwarding the output back to the input of the parser, the two memories can be combined. When the memories are combined as shown in FIG. 13, the reduce action would need to automatically loop around and access the goto table after the stack is popped during the reduce action.

Like LL(1) parser, the LR(1) parser also can be divided as 2-stage pipeline processor with fetch stage 1301 and execute stage 1302. Therefore, it also would require two or more executing pattern threads to fully utilize the engine. The in put FIFO 1303 provides instructions through the selector 1304 to memory 1305. The output of memory 1305 is provided to instruction decoder 1306. Instruction decoder 1306 is coupled to register 1307 and stack 1308. Register 1307 provides output 1309.

Parsing Processor

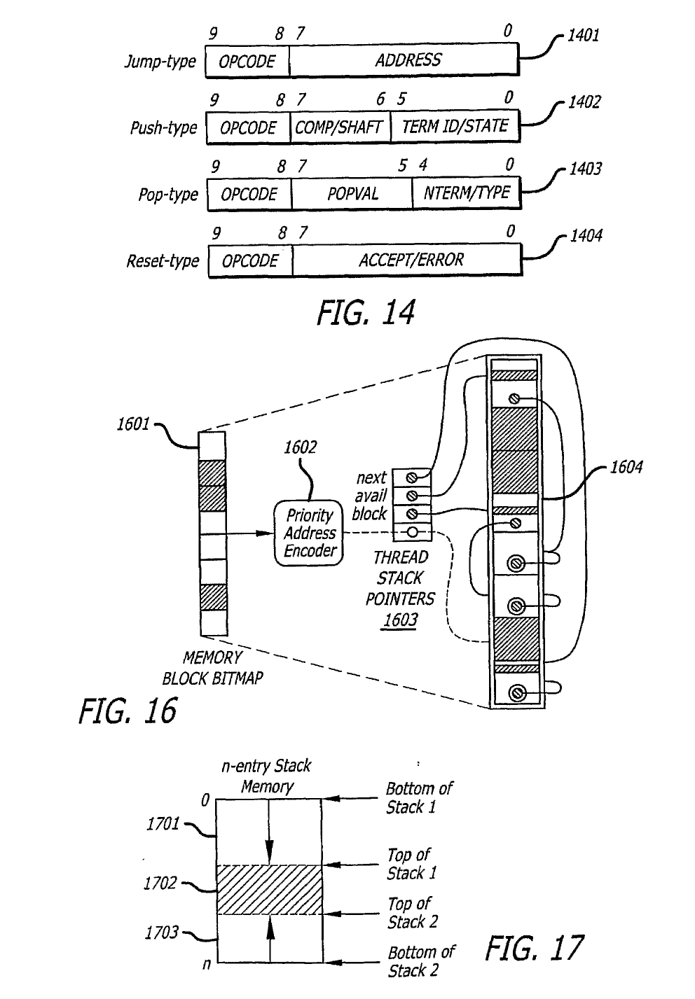

After examining both parser designs, it can be seen that the two datapaths can be combined. Therefore, a new extended set of instruction set architecture is devised. The example instruction types shown in FIG. 14 (1401-1404) are for a parser that supports up to 64 different kinds of terms for LL(1) parsing and 32 non-terminals and 256 states for LR(1) parsing.

Table 3 is a combined instruction set for LL(1) and LR(1) parsers. Although the instructions are mapped in to common fields of the instruction types, none of the instructions are combined due to their different approach of parsing.

TABLE 3

| | Instruction | Function |
|---|---|---|
| 1 | JUMP.1(X) | Jump to address X |
| 2a | PUSH.1(X) | Push term X into the stack |
| | | Jump to the current address +1 |
| 2b | PUSHC.1(X) | Push term X into the stack |
| | | Compare the stack output with the |
| | | token |
| 2c | PUSH.r(X) | Push state X into the stack |
| 2d | PUSHS.r(X) | Push state X into the stack |
| | | Shift to the next token |
| 3a | NOPOP.1(0.0) | Compare the stack output with the |
| | | token |
| 3b | POP.1(0,1) | Pop the stack |
| | | Compare the stack output with the |
| | | token |
| 3c | POP.r(X) | Pop top X > 0 states of the stack |
| | | Use the Goto table with non-term Y |
| 4a | RST/ERR.1 | Reset the stack pointer |
| | | Push start term into the stack |
| 4b | REST/ERR.r | Reset the stack pointer |
| 4c | ACCEPT.r | Reset the stack pointer |
| | | Assert the accept signal |

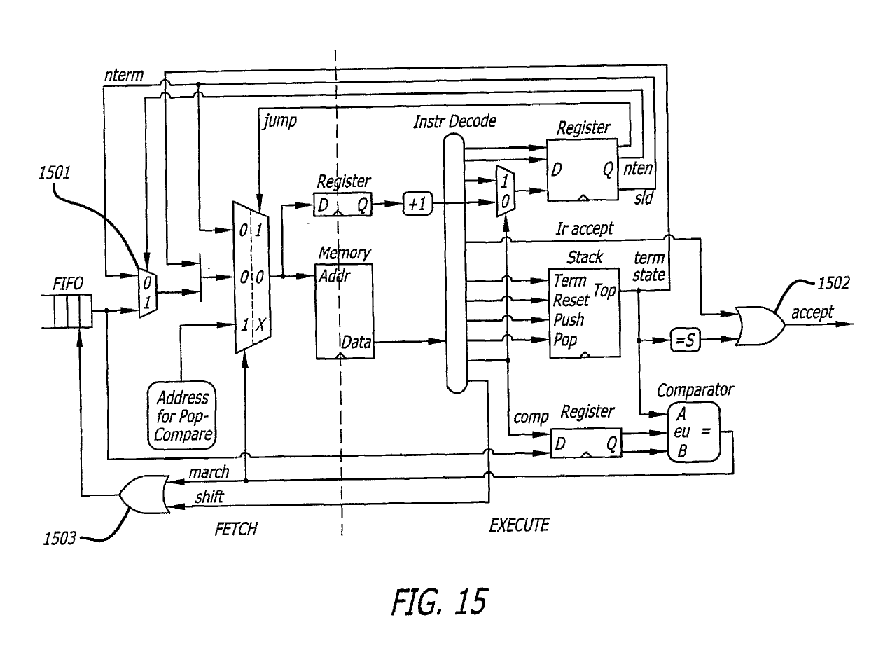

According to the logic layout, all the major components can be the same for both parsers without significant modifications. Therefore, the modified datapath (FIG. 15) is not much larger than either of the previously described parsers. It is similar to the system of FIG. 10 but with the addition of selector 1501, NOR Gate 1502 and NOR Gate 1503.

The following example shows the memory content of the parser for LL(1) grammar. Table 4 is direct mapping of the calculator example. As it is apparent from the memory content, the order of the instructions are dependent on the terminal and non-terminal symbols except when more than one symbol are to be pushed onto the stack. In such situation, the jump instruction loads the instruction counter from a specific address where the push instructions are executed sequentially until the last symbol is pushed. Then the new instruction address is obtained based on the stack and token buffer output. In LL(1) parsing, the instructions to push production terms onto the stack are used more than once. For such cases, the jump instruction allows the set of instructions to be reused.

TABLE 4

| Index | | | Data |
|---|---|---|---|
| Addr | Term | NTerm | Instruction |
| 0 | id=0 | E=0 | JUMP.1(addr=5) |
| 1 | id=0 | E′1 | ERR.1 |
| 2 | id=0 | T=2 | JUMP.1(addr=13) |
| 3 | id=0 | T′3 | ERR.1 |
| 4 | id=0 | F=4 | PUSHC.1(0:id=0) |
| 5 | . . . | . . . | PUSH.1(1:E′=1) |
| 6 | . . . | . . . | PUSHC.1(1:T=2) |
| 7 | . . . | . . . | usused |
| 8 | “+”=1 | E=0 | ERR.1 |
| 9 | “+”=1 | E′=1 | JUMP.1(addr=45) |
| 10 | “+”=1 | T=2 | ERR.1 |
| 11 | “+”=1 | T′=3 | NOPOP.1 |
| 12 | “+”=1 | F=4 | ERR.1 |
| 13 | . . . | . . . | PUSH.1(1:T′=3) |
| 14 | . . . | . . . | PUSHC.1(1:F=4) |
| 15 | . . . | . . . | unused |
| 16-20 | “x”=2 | 0-4 | . . . |
| 21-24 | . . . | . . . | . . . |
| 24 | “(”=0 | E=0 | JUMP.1(addr=5) |
| 25 | “(”=0 | E′=1 | ERR.1 |
| 26 | “(”=0 | T=2 | JUMP.1(addr=13) |
| 27 | “(”=0 | T′=3 | ERR.1 |
| 28 | “(”=0 | F=4 | JUMP.1(addr=29) |
| 29 | . . . | . . . | PUSH.1(0:“(”=4) |
| 30 | . . . | . . . | PUSH.1(1:E=0) |
| 31 | . . . | . . . | PUSHC.1(0:“(”=3 |
| 32-36 | “)”=4 | 0-4 | |
| 37-39 | . . . | . . . | . . . |
| 40-44 | “$”=5 | 0-4 | . . . |
| 45 | . . . | . . . | PUSH.1(1:E′=1) |
| 46 | . . . | . . . | PUSH.1(1:T=2) |
| 47 | . . . | . . . | PUSHC.1(0:“x”=3) |

In a similar manner, the tables for LR(1) parser can be expressed using the LR(1) instruction set. The microcode for each components are determined by the instruction decoders to correctly move the data to obtain accurate result for both type of parsers.

Multiple Thread Parser

As mentioned in previous sections, the parser is capable of parsing more than a single thread. The parsers described above are 2-stage pipeline processors. Therefore, the best bandwidth can be achieved when the number of active threads is more than one. However, to shorten the critical path of the design, one may want to increase the number of pipeline stages. In such case, the stack that handles all of the parsing must be equipped to handle multiple threads.

One way of achieving multi-threading is to have multiple stacks that automatically rotate according to the thread. This method requires the duplicate copies of control logic and for most instances, wastes memory. Another method is to simulate multiple stacks by dividing the memory into multiple address ranges. This method requires less control logic but the memory is still wasted. Therefore, we have designed a single memory that behaves as multiple memories by allotting chains of memory blocks for each token thread.

The stack design in one embodiment is to break the memory into smaller blocks. By using pointers, stacks can be created and destroyed for the threads as necessary. As shown in FIG. 16, the thread stack pointers 1603 are used to keep track of valid threads. At the same time, there is a set of pointers that corresponds to each block that is used to determine the chain of blocks that are used for each live thread. Finally, a bitmap 1601 coupled to priority address encoder 1603 to indicate which memory blocks are in use. As stacks change in size, the bitmap is used to provide the next available block from memory 1604.

For the parsers describe in this section, at most two threads can execute at one time. By setting the constraint to allow execution of two threads, the stack can be further simplified. As shown in FIG. 17, memory can be divided such that one thread will push the data from top towards bottom, whereas the other thread can push the data from bottom towards top of the memory. The memory has a section 1701 for stack 1 and a section 1703 for stack 2, with a section 1702 between that can be used by either as long as the pointers to the top of the pointer do not cross over.

What is claimed is:

1. An apparatus for inspecting a packet stream comprising:
an inspection block for inspecting the packet stream;
a tokenizer coupled to the inspection block for converting the output of the inspection block to a stream of tokens;
a parser for receiving the token stream and for verifying grammatical structure of the token stream.

2. The apparatus of claim 1 wherein the inspection block includes a header inspector and a payload inspector.

3. The apparatus of claim 2 wherein the inspection block outputs a pattern index.

4. The apparatus of claim 3 further including a plurality of parsers coupled to the tokenizer.

5. The apparatus of claim 4 wherein the packet stream is examined at each byte alignment.

6. The apparatus of claim 3 wherein the tokenizer comprises:
an adder coupled to the pattern index stream;
a FIFO control block coupled to the adder;
a FIFO coupled to the FIFO control block.

7. The apparatus of claim 6 further including a plurality of FIFO controllers and a plurality of FIFOs.

8. The apparatus of claim 6 wherein the FIFO controller adds the length of a newly detected token to a detection time to determine a next expected valid token.

9. The apparatus of claim 1 wherein the parser is an LL parser.

10. The apparatus of claim 1 wherein the parser is an LR parser.

11. The apparatus of claim 1 wherein the parser is a combined LL and LR parser.

12. The apparatus of claim 1 wherein the parser includes a stack.

13. The apparatus of claim 12 wherein the stack is a multiple thread stack.

14. The apparatus of claim 12 wherein the stack is two thread stack.
